(19) United States
(12) Patent Application Publication
(10) Pub. No.: US 2026/0312135 A1
(43) Pub. Date: Oct. 8, 2026

(54) SECONDARY BATTERY AND ELECTRONIC APPARATUS

(71) Applicant: Ningde Amperex Technology Limited, Ningde (CN)

(72) Inventors: Junhua JIAN, Ningde (CN); Jianyu LIU, Ningde (CN); Xianhai LU, Ningde (CN); Chao TANG, Ningde (CN)

(73) Assignee: Ningde Amperex Technology Limited, Ningde (CN)

(21) Appl. No.: 19/575,978

(22) Filed: Mar. 24, 2026

(30) Foreign Application Priority Data
Apr. 3, 2025 (CN) 202510420855.8

(51) Int. Cl. H01M 10/0567; H01M 10/0525; H01M 10/0569

(52) U.S. Cl. CPC H01M 10/0567; H01M 10/0525; H01M 10/0569; H01M 2300/0037

(57) ABSTRACT

A secondary battery includes a negative electrode plate and an electrolyte solution including a sulfonyl compound. The sulfonyl compound includes at least one selected from the group consisting of a compound of Formula I and a compound of Formula II. Based on a mass of the electrolyte solution, a mass percentage of the sulfonyl compound is W₁%, and 10≤W₁≤90. The negative electrode plate includes a negative electrode current collector and a negative electrode material layer disposed on at least one surface of the negative electrode current collector. The negative electrode material layer includes carbon nanotube clusters and silicon-based particles. The carbon nanotube cluster includes multiple carbon nanotubes, an average diameter of the carbon nanotube clusters is in the range of D μm, and 0.2≤D≤6.5.

### CROSS-REFERENCE TO RELATED APPLICATION

The present application claims priority to Chinese Patent application No. 202510420855.8 filed in the China National Intellectual Property Administration on Apr. 3, 2025, the entire content of which is hereby incorporated by reference.

### TECHNICAL FIELD

The present application relates to the field of electrochemical technology, in particular to a secondary battery and an electronic apparatus.

### BACKGROUND

Secondary batteries such as lithium-ion batteries have significant advantages such as high energy density, small size, and light weight, and are widely used in mobile phones, notebook computers, tablet computers, drones, electric vehicles, electric tools, power storage systems, and the like. Typically, a lithium-ion battery includes a positive electrode plate, a negative electrode plate, and an electrolyte solution, where the electrolyte solution is responsible for maintaining ion transport between the positive electrode plate and the negative electrode plate, and also responsible for maintaining a stable interface to enable stable operation of the lithium-ion battery. Currently, users have imposed increasingly high requirements on the performance of secondary batteries, such as cycling performance and rate performance. Therefore, there is an urgent need to provide a secondary battery with good cycling performance and rate performance to meet the increasingly high usage demands of people.

### SUMMARY

The present application is intended to provide a secondary battery and an electronic apparatus to improve the cycling performance and rate performance of the secondary battery. The specific technical solution is as follows.

It should be noted that in the summary of the present application, a lithium-ion battery is used as an example of the secondary battery to explain the present application, but the secondary battery of the present application is not limited to lithium-ion batteries. The specific technical solution is as follows.

A first aspect of the present application provides a secondary battery including a negative electrode plate and an electrolyte solution. The electrolyte solution includes a sulfonyl compound. The sulfonyl compound includes at least one selected from the group consisting of a compound of Formula I and a compound of Formula II, a chemical formula of the compound of Formula I is:

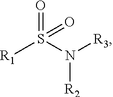

and a chemical formula of the compound of Formula II is:

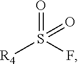

where R₁ is selected from a fluorine atom and a C₁ to C₅ alkyl group, the C₁ to C₅ alkyl group is entirely or partially substituted by fluorine, R₂ and R₃ are each independently selected from a C₁ to Cs alkyl group, R₂ and R₃ are capable of being connected into a ring through a single bond, and R₄ is selected from an unsubstituted or fluorine-substituted C₁ to C₅ alkyl group. Based on a mass of the electrolyte solution, a mass percentage of the sulfonyl compound is W₁%, and 10≤W₁≤90. The negative electrode plate includes a negative electrode current collector and a negative electrode material layer disposed on at least one surface of the negative electrode current collector. The negative electrode material layer includes carbon nanotube clusters and silicon-based particles, an average diameter of the carbon nanotube clusters is in the range of D μm, and 0.2≤D≤6.5. The “carbon nanotube cluster” includes multiple carbon nanotubes, where at least partial regions of the multiple carbon nanotubes are in contact and the contact regions exhibit a bunchy arrangement, and at least partial regions of long axes of the multiple carbon nanotubes are parallel to each other. In the present application, by introducing the sulfonyl compound within the above range into the electrolyte solution, and regulating a D value of the carbon nanotube clusters in the negative electrode material layer within the above range, the electrolyte solution and the carbon nanotube clusters with a specific D value synergize to form a solid electrolyte solution interface film (SEI film) having high toughness and rich in inorganic substances such as lithium fluoride on surfaces of the silicon-based particles, thereby improving the stability of a negative electrode interface, reducing side reactions between the negative electrode material layer and the electrolyte solution, and improving the cycling stability of the secondary battery. In addition, the carbon nanotube clusters can be attached to the silicon-based particles, so that more conductive channels are constructed between the silicon-based particles, increasing the transmission rate of electrons between the silicon-based particles, thereby improving the cycling performance and rate performance of the secondary battery as well as achieving a high energy density.

In some embodiments of the present application, the compound of Formula I includes at least one of the following compounds:

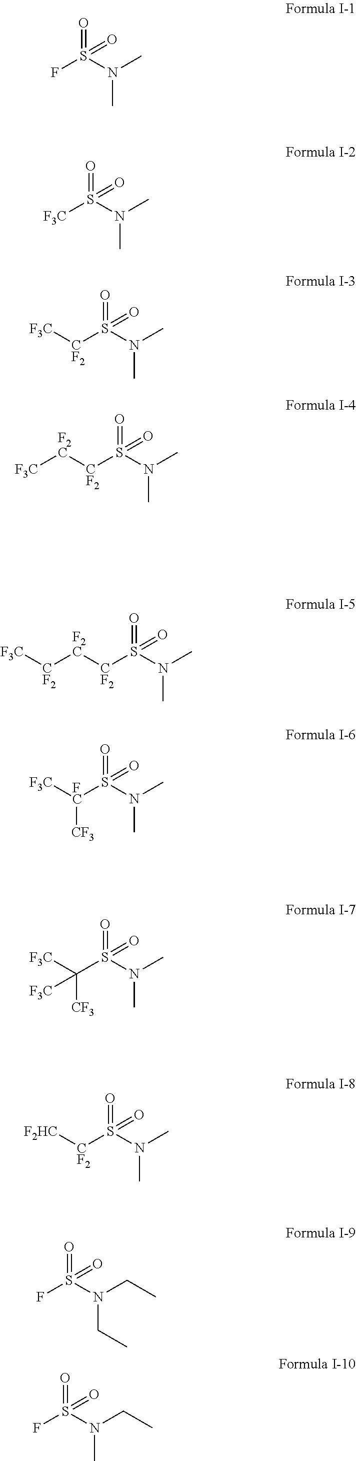

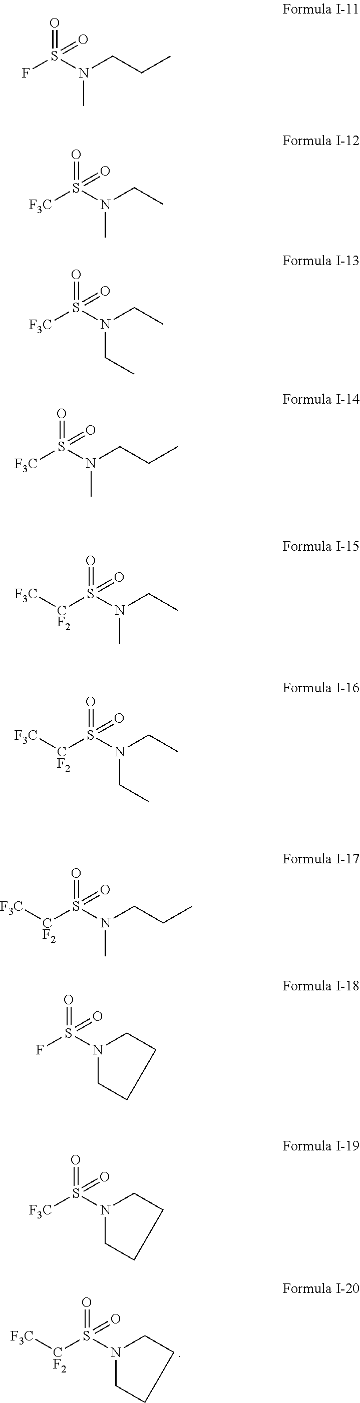

The use of the above compound of Formula I is conducive to forming a solid electrolyte solution interface film (SEI film) rich in inorganic substances such as lithium fluoride on the surfaces of the silicon-based particles, improving the stability of the negative electrode interface, reducing side reactions between the negative electrode material layer and the electrolyte solution, and improving the cycling stability of the secondary battery, thereby facilitating further improvement of the cycling performance of the secondary battery as well as achieving good rate performance.

In some embodiments of the present application, the compound of Formula II includes at least one of the following compounds:

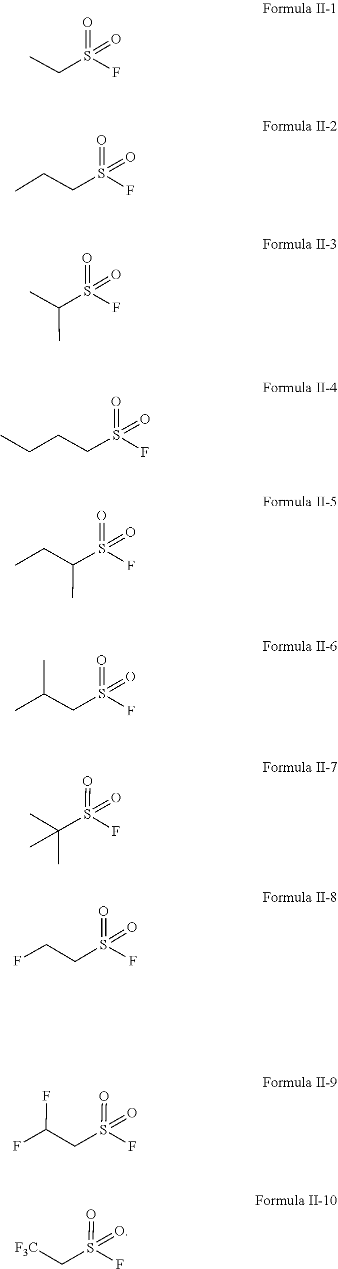

The use of the above compound of Formula II is conducive to forming a solid electrolyte solution interface film (SEI film) rich in inorganic substances such as lithium fluoride on the surfaces of the silicon-based particles, improving the stability of the negative electrode interface, reducing side reactions between the negative electrode material layer and the electrolyte solution, and improving the cycling stability of the secondary battery, thereby facilitating further improvement of the cycling performance of the secondary battery as well as achieving good rate performance.

In some embodiments of the present application, the secondary battery satisfies at least one of the following conditions: (1) 20≤W₁≤70; or (2) 0.5≤D≤5. The secondary battery satisfying the above conditions is conducive to further improving the cycling performance and rate performance of the secondary battery.

In some embodiments of the present application, the electrolyte solution further includes a first component. The first component includes at least one of fluoroethylene carbonate, difluoroethylene carbonate, vinylene carbonate, and ethylene vinyl carbonate. Based on the mass of the electrolyte solution, a mass percentage of the first component is W₂%, 0.5≤W₂≤15, and preferably, 1≤W₂≤8. Using an electrolyte solution including the above type of first component, and regulating the mass percentage W₂% of the first component within the above ranges is conducive to improving the cycling performance and rate performance of the secondary battery.

In some embodiments of the present application, an average diameter of the carbon nanotubes is in the range of d nm, 3≤d≤40, and preferably, 5≤d≤20. By regulating the average diameter d of the carbon nanotubes within the above range, the carbon nanotube clusters are more easily attached to the silicon-based particles, which is conducive to constructing more conductive channels between the silicon-based particles, increasing the transmission rate of electrons between the silicon-based particles, thereby facilitating improvement of the cycling performance and rate performance of the secondary battery.

In some embodiments of the present application, an average length of the carbon nanotube clusters is in the range of L μm, 3≤L≤40, and preferably, 5≤L≤30. By regulating the average length L of the carbon nanotube clusters within the above range, the carbon nanotube clusters can be attached to the silicon-based particles, which is conducive to constructing more conductive channels between the silicon-based particles, increasing the transmission rate of electrons between the silicon-based particles, thereby facilitating improvement of the cycling performance and rate performance of the secondary battery.

In some embodiments of the present application, the silicon-based particles include at least one of pure silicon, silicon alloy, a silicon-carbon composite material, or a silicon-oxygen composite material. The use of the above materials for the silicon-based particles is conducive to increasing the energy density of the secondary battery while the secondary battery has good cycling performance and rate performance.

In some embodiments of the present application, the carbon nanotubes include multi-walled carbon nanotubes.

In some embodiments of the present application, based on a mass of the negative electrode material layer, a mass percentage of the carbon nanotube clusters is 0.1% to 2%. Regulating the mass percentage of the carbon nanotube clusters within the above range is conducive to constructing more conductive channels between the silicon-based particles to form a long-range conductive network, increasing the transmission rate of electrons between the silicon-based particles, thereby facilitating improvement of the cycling performance and rate performance of the secondary battery while the secondary battery has a high energy density.

A second aspect of the present application provides an electronic apparatus including the secondary battery in any of the above embodiments. The electronic apparatus of the present application has good use performance.

Beneficial effects of the present application are as follows.

The present application provides a secondary battery and an electronic apparatus. The secondary battery includes a negative electrode plate and an electrolyte solution. The electrolyte solution includes a sulfonyl compound. The sulfonyl compound includes at least one selected from the group consisting of a compound of Formula I and a compound of Formula II. Based on a mass of the electrolyte solution, a mass percentage of the sulfonyl compound is W₁%, and 10≤W₁≤90. The negative electrode plate includes a negative electrode current collector and a negative electrode material layer disposed on at least one surface of the negative electrode current collector. The negative electrode material layer includes carbon nanotube clusters and silicon-based particles, an average diameter of the carbon nanotube clusters is in the range of D μm, and 0.2≤D≤6.5. In the present application, by introducing the sulfonyl compound within the above range into the electrolyte solution, and regulating a D value of the carbon nanotube clusters in the negative electrode material layer within the above range, the electrolyte solution and the carbon nanotube clusters with a specific D value synergize to form a solid electrolyte solution interface film (SEI film) having high toughness and rich in inorganic substances such as lithium fluoride on surfaces of the silicon-based particles, improving the stability of a negative electrode interface, reducing side reactions between the negative electrode material layer and the electrolyte solution, and improving the cycling stability of the secondary battery. In addition, the carbon nanotube clusters can be attached to the silicon-based particles, so that more conductive channels are constructed between the silicon-based particles, increasing the transmission rate of electrons between the silicon-based particles, thereby improving the cycling performance and rate performance of the secondary battery as well as achieving a high energy density.

Certainly, implementing any product or method of the present application does not necessarily require to achieve all the advantages described above simultaneously.

### DETAILED DESCRIPTION

The technical solutions in the present application are clearly and completely described below in conjunction with some embodiments of the present application. Obviously, the described embodiments are only some embodiments rather than all embodiments of the present application. All other embodiments obtained by those skilled in the art based on the present application belong to the protection scope of the present application.

It should be noted that in specific embodiments of the present application, a lithium-ion battery is used as an example of the secondary battery to explain the present application, but the secondary battery of the present application is not limited to lithium-ion batteries. The specific technical solution is as follows.

A first aspect of the present application provides a secondary battery including a negative electrode plate and an electrolyte solution. The electrolyte solution includes a sulfonyl compound. The sulfonyl compound includes at least one selected from the group consisting of a compound of Formula I and a compound of Formula II, a chemical formula of the compound of Formula I is:

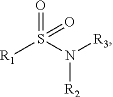

and a chemical formula of the compound of Formula II is:

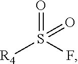

where R₁ is selected from a fluorine atom and a C₁ to C₅ alkyl group, the C₁ to C₅ alkyl group is entirely or partially substituted by fluorine, R₂ and R₃ are each independently selected from a C₁ to C₅ alkyl group, R₂ and R₃ are capable of being connected into a ring through a single bond, and R₄ is selected from an unsubstituted or fluorine-substituted C₁ to C₅ alkyl group. Based on a mass of the electrolyte solution, a mass percentage of the sulfonyl compound is W₁%, 10≤W₁≤90, and preferably, 20≤W₁≤70. For example, a value of W₁ may be 10, 12, 15, 18, 20, 22, 25, 28, 30, 32, 35, 38, 40, 42, 45, 48, 50, 52, 55, 58, 60, 62, 65, 68, 70, 72, 75, 78, 80, 82, 85, 88, 90, or a range defined by any two of these values. The negative electrode plate includes a negative electrode current collector and a negative electrode material layer disposed on at least one surface of the negative electrode current collector. The negative electrode material layer includes carbon nanotube clusters and silicon-based particles. The carbon nanotube cluster includes multiple carbon nanotubes. An average diameter of the carbon nanotube clusters is in the range of D μm, 0.2≤D≤6.5, and preferably, 0.5≤D≤5. For example, a value of D may be 0.2, 0.5, 0.8, 1.0, 1.5, 2.0, 2.5, 3.0, 3.5, 4.0, 4.5, 5.0, 5.5, 6.0, 6.5, or a range defined by any two of these values.

The “carbon nanotube cluster” includes multiple carbon nanotubes, where at least partial regions of the multiple carbon nanotubes are in contact and the contact regions exhibit a bunchy arrangement, and at least partial regions of long axes of the multiple carbon nanotubes are parallel to each other. Being parallel to each other includes a situation where an angle between the long axes of the carbon nanotubes is less than or equal to 20°. During a diameter test of the carbon nanotube clusters, regions where the multiple carbon nanotubes are in contact with each other and the long axes are parallel to each other are selected for testing.

The negative electrode material layer of the present application includes silicon-based particles. The silicon-based particles have high gram capacity and can increase the energy density of the secondary battery. In addition, the sulfonyl compound contained in the electrolyte solution can form a solid electrolyte solution interface film (SEI film) rich in inorganic substances such as lithium fluoride on the surfaces of the silicon-based particles, improving the stability of the negative electrode interface, reducing side reactions between the negative electrode material layer and the electrolyte solution, and improving the cycling stability of the secondary battery, thereby improving the cycling performance of the secondary battery. However, the SEI film rich in inorganic substances on a negative electrode surface affects the electron transmission between silicon-based particles, thereby affecting the rate performance of the secondary battery. In the present application, by adding carbon nanotube clusters to the negative electrode material layer and regulating the average diameter D of the carbon nanotube clusters within the ranges provided in the present application, the carbon nanotube clusters can be attached to the silicon-based particles, so that more conductive channels are constructed between the silicon-based particles, increasing the transmission rate of electrons between the silicon-based particles, thereby improving the rate performance of the secondary battery. Therefore, in the present application, by introducing the sulfonyl compound within the above range into the electrolyte solution, and regulating the D value of the carbon nanotube clusters in the negative electrode material layer within the above ranges, the electrolyte solution and the negative electrode plate synergize to improve the cycling performance and rate performance of the secondary battery as well as achieve a high energy density.

When the value of W₁ is too small, for example, less than 10, it is difficult to form an SEI film rich in inorganic substances such as lithium fluoride on the surfaces of the silicon-based particles, causing poor stability of the negative electrode interface, more side reactions between the negative electrode material layer and the electrolyte solution, and poor cycling stability of the secondary battery, thereby affecting the cycling performance of the secondary battery. When the value of W₁ is too large, for example, greater than 90, the SEI film rich in inorganic substances on the negative electrode surface is relatively thick, hindering ion transport and also affecting the electron transmission between silicon-based particles, thereby affecting the cycling performance and rate performance of the secondary battery. When the value of D is too small, for example, less than 0.2, the transmission rate of electrons between silicon-based particles is small, thereby affecting the cycling performance and rate performance of the secondary battery. When the value of D is too large, for example, greater than 6.5, the carbon nanotube clusters are prone to agglomeration in a negative electrode slurry and are less likely to be attached to the silicon-based particles to form a high-efficiency electron network, thereby affecting the cycling performance and rate performance of the secondary battery.

In some embodiments, R₁ is selected from a fluorine atom, difluoromethyl, trifluoromethyl, tetrafluoroethyl, pentafluoroethyl, heptafluoropropyl, or nonafluorobutyl; R₂ is selected from methyl, ethyl, propyl, or butyl; R₃ is selected from methyl, ethyl, propyl, or butyl; and R₄ is selected from methyl, ethyl, propyl, butyl, pentyl, monofluoroethyl, difluoroethyl, or trifluoroethyl. The sulfonyl compound containing groups within the above ranges is conducive to forming an SEI film rich in inorganic substances such as lithium fluoride on the surfaces of the silicon-based particles, improving the stability of the negative electrode interface, thereby facilitating improvement of the cycling performance of the secondary battery as well as achieving good rate performance.

In some embodiments of the present application, the compound of Formula I includes at least one of the following compounds:

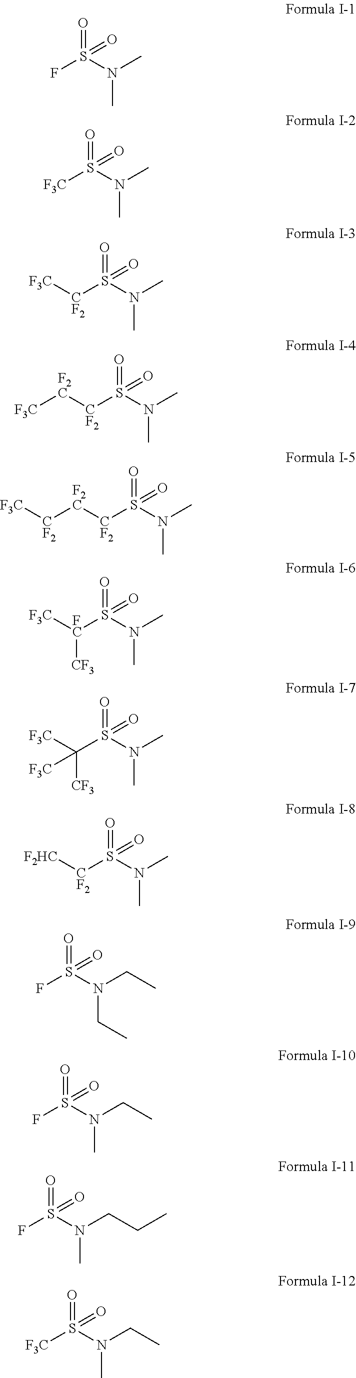

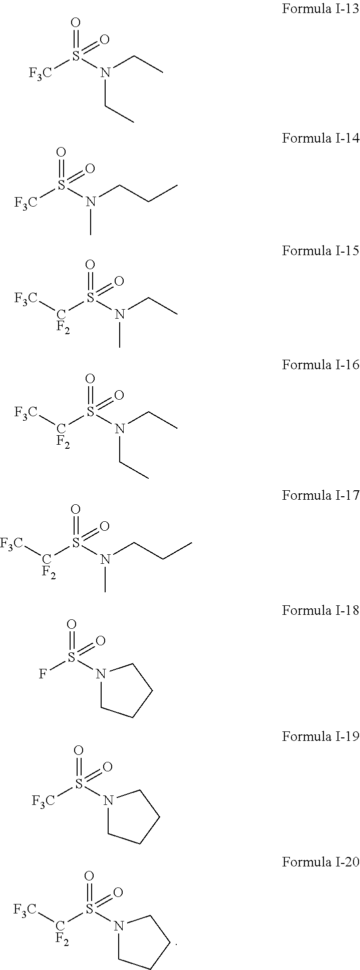

The use of the above compound of Formula I is conducive to forming an SEI film rich in inorganic substances such as lithium fluoride on the surfaces of the silicon-based particles, improving the stability of the negative electrode interface, reducing side reactions between the negative electrode material layer and the electrolyte solution, and improving the cycling stability of the secondary battery. In addition, the compound of Formula I can synergize with the negative electrode plate containing carbon nanotube clusters, thereby facilitating further improvement of the cycling performance of the secondary battery as well as achieving good rate performance.

In some embodiments of the present application, the compound of Formula II includes at least one of the following compounds:

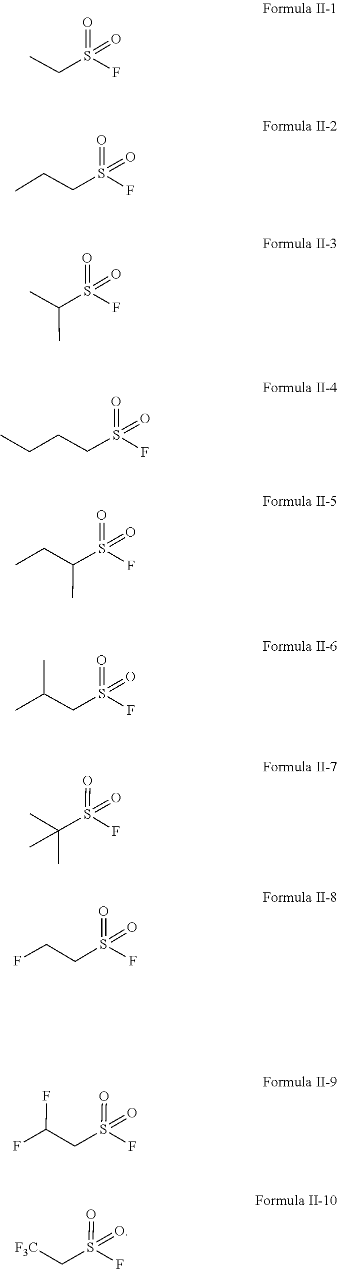

The use of the above compound of Formula II is conducive to forming an SEI film rich in inorganic substances such as lithium fluoride on the surfaces of the silicon-based particles, improving the stability of the negative electrode interface, reducing side reactions between the negative electrode material layer and the electrolyte solution, and improving the cycling stability of the secondary battery. In addition, the compound of Formula II can synergize with the negative electrode plate containing carbon nanotube clusters, thereby facilitating further improvement of the cycling performance of the secondary battery as well as achieving good rate performance.

In some embodiments of the present application, the electrolyte solution further includes a first component. The first component includes at least one of fluoroethylene carbonate, difluoroethylene carbonate, vinylene carbonate, and ethylene vinyl carbonate. The use of an electrolyte solution including the above type of first component facilitates synergism with the sulfonyl compound to form a tough and dense SEI film on the negative electrode surface, reducing contact between a negative electrode active material and the electrolyte solution, and reducing side reactions between the negative electrode material layer and the electrolyte solution, thereby enabling the secondary battery to have a longer cycle life and improving the cycling stability of the secondary battery. In addition, the electrolyte solution can synergize with the negative electrode plate containing carbon nanotube clusters, thereby facilitating improvement of the cycling performance and rate performance of the secondary battery.

In some embodiments of the present application, based on the mass of the electrolyte solution, a mass percentage of the first component is W₂%, 0.5≤W₂≤15, and preferably, 1≤W₂≤8. For example, a value of W₂ may be 0.5, 0.7, 1, 2, 3, 4, 5, 6, 7, 8, 9, 10, 11, 12, 13, 14, 15, or a range defined by any two of these values. Regulating the mass percentage W₂% of the first component within the above range facilitates synergism with the sulfonyl compound to form a tough and dense SEI film on the negative electrode surface, reducing contact between the negative electrode active material and the electrolyte solution, and reducing side reactions between the negative electrode material layer and the electrolyte solution, thereby enabling the secondary battery to have a longer cycle life and improving the cycling stability of the secondary battery. In addition, the electrolyte solution can synergize with the negative electrode plate containing carbon nanotube clusters, thereby facilitating improvement of the cycling performance and rate performance of the secondary battery.

In the present application, the electrolyte solution further includes a lithium salt and other non-aqueous solvents. The present application has no particular limitation on the lithium salt, as long as the purposes of the present application can be achieved. For example, the lithium salt may include but is not limited to at least one of LiPF₆, LiBF₄, LiAsF₆, LiClO₄, LiB(C₆H₅)₄, LiCH₃SO₃, LiCF₃SO₃, LiN(SO₂CF₃)₂, LiC(SO₂CF₃)₃, Li₂SiF₆, lithium bis(oxalato) borate (LiBOB), or lithium difluoroborate. The present application has no particular limitation on the percentage of the lithium salt in the electrolyte solution, as long as the purposes of the present application can be achieved. For example, based on the mass of the electrolyte solution, a mass percentage of the lithium salt is 8% to 30%.

The present application has no particular limitation on other non-aqueous solvents, as long as the purposes of the present application can be achieved. For example, the other non-aqueous solvents may include but are not limited to at least one of carbonate compounds, carboxylate compounds, ether compounds, or other organic solvents.

The carbonate compounds may include but are not limited to at least one of chain carbonate compounds, cyclic carbonate compounds, or fluorocarbonate compounds. The chain carbonate compounds may include but are not limited to at least one of dimethyl carbonate (DMC), diethyl carbonate (DEC), dipropyl carbonate (DPC), methyl propyl carbonate (MPC), ethyl propyl carbonate (EPC), or methyl ethyl carbonate (MEC). The cyclic carbonate compounds may include but are not limited to at least one of ethylene carbonate (EC), propylene carbonate (PC), or butylene carbonate (BC). The fluorocarbonate compounds may include but are not limited to at least one of 1,2-difluoroethylene carbonate, 1,1-difluoroethylene carbonate, 1,1,2-trifluoroethylene carbonate, 1,1,2,2-tetrafluoroethylene carbonate, 1-fluoro-2-methylethylene carbonate, 1-fluoro-1-methylethylene carbonate, 1,2-difluoro-1-methylethylene carbonate, 1,1,2-trifluoro-2-methylethylene carbonate, or trifluoromethylethylene carbonate. The carboxylate compounds may include but are not limited to at least one of methyl formate, methyl acetate, ethyl acetate, n-propyl acetate, tert-butyl acetate, methyl propionate, ethyl propionate, propyl propionate, γ-butyrolactone, decalactone, valerolactone, or caprolactone. The ether compounds may include but are not limited to at least one of dibutyl ether, tetraethylene glycol dimethyl ether, diethylene glycol dimethyl ether, 1,2-dimethoxyethane, 1,2-diethoxyethane, 1-ethoxy-1-methoxyethane, 2-methyltetrahydrofuran, or tetrahydrofuran. The other organic solvents may include but are not limited to at least one of dimethyl sulfoxide, 1,2-dioxolane, sulfolane, methylsulfolane, 1,3-dimethyl-2-imidazolidinone, N-methyl-2-pyrrolidone, dimethylformamide, acetonitrile, trimethyl phosphate, triethyl phosphate, or trioctyl phosphate. The present application has no particular limitation on the percentage of the other non-aqueous solvents in the electrolyte solution, as long as the purposes of the present application can be achieved. For example, based on the mass of the electrolyte solution, a mass percentage of the other non-aqueous solvents is 0% to 81.5%.

In some embodiments, the electrolyte solution may include a sulfonyl compound, a lithium salt, and other non-aqueous solvents, and mass percentages of the sulfonyl compound, lithium salt, and other non-aqueous solvents are as described above. The secondary battery including the above electrolyte solution has good cycling performance and rate performance.

In some embodiments, the electrolyte solution may include a sulfonyl compound, a first component, a lithium salt, and other non-aqueous solvents, and mass percentages of the sulfonyl compound, first component, lithium salt, and other non-aqueous solvents are as described above. The secondary battery including the above electrolyte solution has good cycling performance and rate performance.

In some embodiments of the present application, an average diameter of the carbon nanotubes is in the range of d nm, 3≤d≤40, and preferably, 5≤d≤20. For example, a value of d may be 3, 5, 8, 10, 12, 15, 18, 20, 22, 25, 28, 30, 32, 35, 38, 40, or a range defined by any two of these values. By regulating the average diameter d of the carbon nanotubes within the above ranges, the carbon nanotube clusters can be attached to the silicon-based particles, which is conducive to constructing more conductive channels between the silicon-based particles, increasing the transmission rate of electrons between the silicon-based particles. In addition, the carbon nanotubes can synergize with the electrolyte solution containing the sulfonyl compound, thereby facilitating improvement of the cycling performance and rate performance of the secondary battery.

In some embodiments of the present application, an average length of the carbon nanotube clusters is in the range of L μm, 3≤L≤40, and preferably, 5≤L≤30. For example, a value of L may be 3, 5, 8, 10, 12, 15, 18, 20, 22, 25, 28, 30, 32, 35, 38, 40, or a range defined by any two of these values. By regulating the average length L of the carbon nanotube clusters within the above ranges, the carbon nanotube clusters can be attached to the silicon-based particles, which is conducive to constructing more conductive channels between the silicon-based particles, increasing the transmission rate of electrons between the silicon-based particles. The process is easy to implement, and the carbon nanotube clusters can synergize with the electrolyte solution containing the sulfonyl compound, thereby facilitating improvement of the cycling performance and rate performance of the secondary battery.

The present application has no particular limitation on a preparation method of carbon nanotube clusters, as long as the purposes of the present application can be achieved. For example, the preparation method of carbon nanotube clusters may include but is not limited to the following steps: adding multi-walled carbon nanotubes and a dispersant at a mass ratio of 1:(0.1 to 10) to a dispersion medium, and mixing these materials uniformly to obtain a mixed solution with a solid content of 1.5 wt % to 20 wt %; and applying a shear force to the mixed solution to obtain a dispersion of carbon nanotube clusters. The dispersant may include but is not limited to at least one of carboxymethyl cellulose, sodium carboxymethyl cellulose, or lithium carboxymethyl cellulose; and the dispersion medium may include but is not limited to at least one of deionized water, dimethylformamide (DMF), diethylformamide, dimethylacetamide (DMAc), N-methylpyrrolidone (NMP), methanol, ethanol, 1-propanol, 2-propanol (isopropanol), 1-butanol (n-butanol), 2-methyl-1-propanol (isobutanol), 2-butanol (sec-butanol), 1-methyl-2-propanol (tert-butanol), pentanol, hexanol, heptanol, or octanol, diol such as ethylene glycol, diethylene glycol, triethylene glycol, propylene glycol, 1,3-propanediol, 1,3-butanediol, 1,5-pentanediol, or hexanediol, glycerol, trimethylolpropane, pentaerythritol, sorbitol, ethylene glycol monomethyl ether, diethylene glycol monomethyl ether, triethylene glycol monomethyl ether, tetraethylene glycol monomethyl ether, ethylene glycol monoethyl ether, diethylene glycol monoethyl ether, triethylene glycol monoethyl ether, tetraethylene glycol monoethyl ether, ethylene glycol monobutyl ether, diethylene glycol monobutyl ether, triethylene glycol monobutyl ether, tetraethylene glycol monobutyl ether, acetone, methyl ethyl ketone, methyl propyl ketone, cyclopentanone, ethyl acetate, γ-butyrolactone, or ¿-propiolactone. Based on a mass of the mixed solution, a mass percentage of the multi-walled carbon nanotubes may be 1% to 4%. Machines for applying a shear force to the mixed solution may include but are not limited to at least one of a homogenizer, a bead mill, a ball mill, a sand mill, a basket mill, a grinder, a general stirrer, a transparent mixer, a pin mill, a mixing apparatus of a TK mixer, or an ultrasonic dispersion device.

In the above preparation method of carbon nanotube clusters, when a ball mill is used to apply a shear force to the mixed solution, specific steps are as follows: adding the mixed solution to a container containing grinding balls, that is, a ball mill; and rotating the container to obtain a dispersion of carbon nanotube clusters, where an average diameter of the grinding balls may be 0.5 mm to 2.5 mm, a rotation speed of the container may be 500 rpm to 6000 rpm, and a ball milling time may be 0.5 h to 2 h.

In the present application, an average diameter D of the carbon nanotube clusters can be regulated by regulating the average diameter of the grinding balls, the rotation speed of the container, and the ball milling time. For example, when other conditions are unchanged, a larger average diameter of the grinding balls results in a larger average diameter D of the carbon nanotube clusters, and a smaller average diameter of the grinding balls results in a smaller average diameter D of the carbon nanotube clusters. When other conditions are unchanged, a lower rotation speed of the container results in a larger average diameter D of the carbon nanotube clusters, and a higher rotation speed of the container results in a smaller average diameter D of the carbon nanotube clusters. When other conditions are unchanged, a shorter ball milling time results in a larger average diameter D of the carbon nanotube clusters, and a longer ball milling time results in a smaller average diameter D of the carbon nanotube clusters.

In the present application, an average length L of the carbon nanotube clusters can be regulated by regulating an average length of the carbon nanotubes. For example, when other conditions are unchanged, as the average length of the carbon nanotubes increases, the average length L of the carbon nanotube clusters increases; and as the average length of the carbon nanotubes decreases, the average length L of the carbon nanotube clusters decreases.

In some embodiments of the present application, the silicon-based particles include at least one of pure silicon, silicon alloy, a silicon-carbon composite material, or a silicon-oxygen composite material (SiOx (0<x≤2)), where the silicon alloy may include at least one of lithium-silicon alloy, silicon-germanium alloy, silicon-tin alloy, or silicon-aluminum alloy; and in the silicon-carbon composite material, a mass ratio of silicon element to carbon element may be 1:(0.4 to 3). The use of the above materials for the silicon-based particles is conducive to increasing the energy density of the secondary battery while the secondary battery has good cycling performance and rate performance.

In some embodiments, based on a mass of the negative electrode material layer, a mass percentage of the silicon-based particles is 5% to 98%. For example, the mass percentage of the silicon-based particles may be 5%, 10%, 15%, 20%, 30%, 35%, 40%, 45%, 50%, 55%, 60%, 70%, 80%, 90%, 98%, or a range defined by any two of these values.

In some embodiments of the present application, based on the mass of the negative electrode material layer, a mass percentage of the carbon nanotube clusters is 0.1% to 2%. For example, the mass percentage of the carbon nanotube clusters may be 0.1%, 0.3%, 0.5%, 0.8%, 1.0%, 1.2%, 1.5%, 1.8%, 2.0%, or a range defined by any two of these values. Regulating the mass percentage of the carbon nanotube clusters within the above range is conducive to constructing more conductive channels between the silicon-based particles to form a long-range conductive network, increasing the transmission rate of electrons between the silicon-based particles. In addition, the carbon nanotube clusters can synergize with the electrolyte solution containing the sulfonyl compound, thereby facilitating improvement of the cycling performance and rate performance of the secondary battery while the secondary battery has a high energy density.

In some embodiments, the negative electrode material layer further includes a negative electrode active material other than the silicon-based particles, and based on the mass of the negative electrode material layer, a mass percentage of the negative electrode active material other than the silicon-based particles is 0% to 90%. For example, the mass percentage of the negative electrode active material other than the silicon-based particles may be 0%, 10%, 20%, 30%, 35%, 40%, 45%, 50%, 55%, 60%, 70%, 80%, 90%, or a range defined by any two of these values. The present application has no particular limitation on a type of the negative electrode active material other than the silicon-based particles, as long as the purposes of the present application can be achieved. For example, the negative electrode active material other than the silicon-based particles may include at least one of natural graphite, artificial graphite, mesocarbon microbeads (MCMB), hard carbon, soft carbon, Li—Sn alloy, Li—Sn—O alloy, Sn, SnO, SnO₂, spinel-structured lithium titanate Li₄Ti₅O₁₂, Li—Al alloy, or metallic lithium.

In some embodiments, the negative electrode material layer further includes a negative electrode binder, and based on the mass of the negative electrode material layer, a mass percentage of the negative electrode binder is 0.5% to 4%. For example, the mass percentage of the negative electrode binder may be 0.5%, 1.0%, 1.5%, 2.0%, 2.5%, 3.0%, 3.5%, 4.0%, or a range defined by any two of these values. The present application has no particular limitation on a type of the negative electrode binder, as long as the purposes of the present application can be achieved. For example, the negative electrode binder may include but is not limited to at least one of polyacrylic acid, sodium polyacrylate, potassium polyacrylate, lithium polyacrylate, polyvinyl alcohol, carboxymethyl cellulose, sodium carboxymethyl cellulose, lithium carboxymethyl cellulose, polyimide, polyamideimide, styrene-butadiene rubber, or polyvinylidene fluoride.

In the present application, the negative electrode plate includes a negative electrode current collector and a negative electrode material layer disposed on at least one surface of the negative electrode current collector. The above “the negative electrode plate includes a negative electrode current collector and a negative electrode material layer disposed on at least one surface of the negative electrode current collector” means that the negative electrode material layer may be disposed on one surface of the negative electrode current collector along a thickness direction of the negative electrode current collector, or may be disposed on two surfaces of the negative electrode current collector along a thickness direction of the negative electrode current collector. It should be noted that the “surface” herein may be an entire region of the surface of the negative electrode current collector, or may be a partial region of the surface of the negative electrode current collector, and the present application has no particular limitation, as long as the purposes of the present application can be achieved.

The present application has no particular limitation on the negative electrode current collector, as long as the purposes of the present application can be achieved. For example, it may include copper foil, copper alloy foil, nickel foil, stainless steel foil, titanium foil, foamed nickel, foamed copper, or a composite current collector. Exemplarily, the composite current collector may be a lithium-copper composite current collector, a carbon-copper composite current collector, a nickel-copper composite current collector, a titanium-copper composite current collector, or the like.

In the present application, thicknesses of the negative electrode current collector and the negative electrode material layer are not particularly limited, as long as the purposes of the present application can be achieved. For example, the thickness of the negative electrode current collector is 4 μm to 20 μm, and the thickness of a single-sided negative electrode material layer is 30 μm to 130 μm.

In the present application, the secondary battery further includes a positive electrode plate. The positive electrode plate includes a positive electrode current collector and a positive electrode material layer disposed on at least one surface of the positive electrode current collector. The above “positive electrode material layer disposed on at least one surface of the positive electrode current collector” means that the positive electrode material layer may be disposed on one surface of the positive electrode current collector along a thickness direction of the positive electrode current collector, or may be disposed on two surfaces of the positive electrode current collector along a thickness direction of the positive electrode current collector. It should be noted that the “surface” herein may be an entire region of the positive electrode current collector, or may be a partial region of the positive electrode current collector, and the present application has no particular limitation, as long as the purposes of the present application can be achieved.

The present application has no particular limitation on the positive electrode current collector, as long as the purposes of the present application can be achieved. For example, it may include aluminum foil, aluminum alloy foil, a composite current collector (such as an aluminum-carbon composite current collector), or the like.

The positive electrode material layer of the present application includes a positive electrode active material, and the positive electrode active material includes a substance capable of reversibly intercalating and deintercalating active ions such as lithium ions. There may be one or multiple positive electrode material layers, and each of the multiple positive electrode material layers may include the same or different positive electrode active materials. The present application has no particular limitation on the positive electrode active material, as long as the purposes of the present application can be achieved. For example, the positive electrode active material may include but is not limited to at least one of lithium nickel cobalt manganese oxide, lithium nickel cobalt aluminum oxide, lithium iron phosphate, lithium-rich manganese-based material, lithium cobalt oxide (LiCoO₂), lithium manganate, lithium iron manganese phosphate, or lithium titanate. The lithium nickel cobalt manganese oxide may include at least one of LiNi_{0.95}Co_{0.03}Mn_{0.02}O₂ (Ni95), LiNi_{0.91}Co_{0.03}Mn_{0.06}O₂ (Ni91), LiNi_{0.8}Co_{0.1}Mn_{0.1}O₂ (NCM811), LiNi_{0.6}Co_{0.2}Mn_{0.2}O₂ (NCM622), LiNi_{0.5}Co_{0.2}Mn_{0.3}O₂ (NCM523), or LiNi_{1/3}Co_{1/3}Mn_{1/3}O₂ (NCM111). In the present application, the positive electrode active material may further include non-metal elements. For example, the non-metal elements include at least one of fluorine, phosphorus, boron, chlorine, silicon, or sulfur.

The positive electrode material layer of the present application further includes a positive electrode conductive agent and a positive electrode binder. The present application has no particular limitation on the positive electrode conductive agent and positive electrode binder in the positive electrode material layer, as long as the purposes of the present application can be achieved. For example, the positive electrode conductive agent may include but is not limited to at least one of conductive carbon black, carbon nanotubes (CNTs), carbon fiber, flake graphite, graphene, metal materials, or conductive polymers, and the conductive carbon black may include but is not limited to at least one of acetylene black or Ketjen black. The carbon nanotubes may include but are not limited to single-walled carbon nanotubes and/or multi-walled carbon nanotubes. The carbon fiber may include but is not limited to vapor-grown carbon fiber (VGCF) and/or nanocarbon fiber. The metal materials may include but are not limited to metal powder and/or metal fiber. Specifically, the metal may include but is not limited to at least one of copper, nickel, aluminum, or silver. The conductive polymers may include but are not limited to at least one of polyphenylene derivatives, polyaniline, polythiophene, polyacetylene, or polypyrrole. The positive electrode binder may be at least one of the above negative electrode binders. The present application has no particular limitation on a mass ratio of the positive electrode active material, positive electrode conductive agent, and positive electrode binder in the positive electrode material layer. Those skilled in the art can select according to actual needs, as long as the purposes of the present application can be achieved.

In the present application, thicknesses of the positive electrode current collector and the positive electrode material layer are not particularly limited, as long as the purposes of the present application can be achieved. For example, the thickness of the positive electrode current collector is 5 μm to 20 μm, preferably 6 μm to 18 μm; and the thickness of a single-sided positive electrode material layer is 30 μm to 120 μm.

In the present application, the secondary battery further includes a separator. The present application has no particular limitation on the separator, as long as the purposes of the present application can be achieved. For example, a material of the separator may include but is not limited to at least one of polyolefin (PO) mainly including polyethylene (PE) and polypropylene (PP), polyester (for example, polyethylene terephthalate (PET) film), cellulose, polyimide (PI), polyamide (PA), spandex, or aramid. A type of the separator may include at least one of a woven film, a non-woven film, a microporous film, a composite film, a rolled film, or a spun film.

In some embodiments, the separator may include a substrate layer and a surface treatment layer. The substrate layer may be a non-woven film or composite film having a porous structure, and a material of the substrate layer may include at least one of polyethylene, polypropylene, polyethylene terephthalate, or polyimide. Optionally, a polypropylene microporous film, a polyethylene microporous film, a polypropylene non-woven fabric, a polyethylene non-woven fabric, or a polypropylene-polyethylene-polypropylene microporous composite film may be used.

Optionally, the surface treatment layer is disposed on at least one surface of the substrate layer, and the surface treatment layer may be a polymer layer or an inorganic substance layer, or may be a layer formed by mixing a polymer and an inorganic substance.

In some embodiments, the inorganic substance layer includes inorganic particles and an inorganic substance layer binder. The present application has no particular limitation on the inorganic particles. For example, the inorganic particles may include at least one of alumina, silica, magnesia, titania, hafnia, tin oxide, ceria, nickel oxide, zinc oxide, calcium oxide, zirconia, yttria, silicon carbide, boehmite, aluminum hydroxide, magnesium hydroxide, calcium hydroxide, or barium sulfate. The present application has no particular limitation on the inorganic substance layer binder. For example, it may be at least one of the above negative electrode binders. In some embodiments, the polymer layer includes a polymer, and a material of the polymer includes at least one of polyamide, polyacrylonitrile, acrylate polymer, polyacrylic acid, polyacrylate, polyvinylpyrrolidone, polyvinyl ether, polyvinylidene fluoride, or poly(vinylidene fluoride-hexafluoropropylene).

In the present application, a thickness of the separator is not particularly limited, as long as the purposes of the present application can be achieved. For example, the thickness of the separator may be 3 μm to 30 μm.

The secondary battery further includes a housing for accommodating the positive electrode plate, separator, negative electrode plate, and electrolyte solution, as well as other components known in the field of secondary batteries. The present application has no limitation on the above other components. The present application has no particular limitation on the housing, which may be a housing well known in the art, as long as the purposes of the present application can be achieved. For example, the housing may be a hard-shell housing or a flexible housing. A material of the hard-shell housing may be metal, and the present application has no limitation on a type of metal, and metal hard-shell housings known in the art may be used, as long as the purposes of the present application can be achieved. The flexible housing may be a metal plastic film, such as an aluminum-plastic film or a steel-plastic film.

The secondary battery of the present application is not particularly limited and may include any apparatus in which an electrochemical reaction takes place. In some embodiments, the secondary battery may include but is not limited to: a lithium-ion secondary battery (lithium-ion battery), a lithium polymer secondary battery, or a lithium-ion polymer secondary battery.

A preparation process of the secondary battery of the present application is well known to those skilled in the art and is not particularly limited in the present application. For example, the preparation process of the secondary battery may include but is not limited to the following steps: a positive electrode plate, a separator, and a negative electrode plate are stacked in sequence; winding, folding, and other operations are performed as needed to obtain a wound electrode assembly; the electrode assembly is placed into a housing; an electrolyte solution is injected into the housing; and the housing is sealed to obtain a secondary battery. Alternatively, a positive electrode plate, a separator, and a negative electrode plate are stacked in sequence; then four corners of the entire stack structure are fixed with tapes to obtain a stacked electrode assembly; the electrode assembly is placed into a housing; an electrolyte solution is injected into the housing; and the housing is sealed to obtain a secondary battery. In addition, an overcurrent prevention element, a guide plate, and the like may be placed in the housing as needed, thereby preventing internal pressure rise, overcharge, and overdischarge of the secondary battery.

A second aspect of the present application provides an electronic apparatus including the secondary battery in any of the above embodiments. The electronic apparatus of the present application has good use performance.

The present application has no particular limitation on a type of the electronic apparatus, which may be any electronic apparatus known in the prior art. In some embodiments, the electronic apparatus may include but is not limited to a notebook computer, a pen-input computer, a mobile computer, an e-book player, a portable phone, a portable fax machine, a portable copier, a portable printer, a headphone stereo, a video recorder, a liquid crystal television, a portable cleaner, a portable CD player, a mini disc player, a transceiver, an electronic notebook, a calculator, a memory card, a portable recorder, a radio, a backup power source, a motor, an automobile, a motorcycle, a power-assisted bicycle, a bicycle, a lighting fixture, a toy, a game console, a watch, an electric tool, a flashlight, a camera, a household large-scale storage battery, and a lithium-ion capacitor.

### EXAMPLES

Some embodiments of the present application are further specifically described below by giving examples and comparative examples. Various tests and evaluations were conducted according to the following methods. In addition, unless otherwise specified, “parts” and “%” are based on mass.

### Test Methods and Devices:

Tests for average diameter D and average length L of carbon nanotube clusters as well as average diameter d of carbon nanotubes

A lithium-ion battery was discharged to 3 V at a constant current of 0.2C, then disassembled to obtain a negative electrode plate sample, and the sample was cleaned with dimethyl carbonate (DMC) and then dried at 60° C. A cross section of the negative electrode plate along a thickness direction was obtained through liquid nitrogen brittle fracture, and the cross section was observed under a scanning electron microscope (SEM). The diameters and lengths of a total of 20 carbon nanotube clusters as well as diameters of carbon nanotubes at 5 different positions were tested, and their average values were calculated to obtain the average diameter D and average length L of the carbon nanotube clusters as well as the average diameter d of the carbon nanotubes.

### Cycling Performance Test

The lithium-ion battery was placed in a constant-temperature environment at 25° C. and left standing for 30 min to reach a constant-temperature state at 25° C. The lithium-ion battery was charged to 4.5 V at a constant current of 0.5C, then charged at a constant voltage of 4.5 V until the current was 0.025C, left standing for 5 min, and discharged to 3.0 V at a constant current of 0.5C. An initial discharge capacity was recorded as C₀, and after the above charge-discharge steps were performed 500 cycles, a discharge capacity after the 500 cycles was recorded as C₁. Cycling capacity retention rate (%)=C₁/C₀×100%.

### Rate Performance Test

The lithium-ion battery was placed in a constant-temperature environment at 25° C. and left standing for 30 min to reach a constant-temperature state at 25° C. The lithium-ion battery was charged to 4.5 V at a constant current of 0.5C, then charged at a constant voltage of 4.5 V until the current was 0.025C, and discharged to 3.0 V at a constant current of 0.2C. A discharge capacity at 25° C. and 0.2C was recorded as C₂. Then, the lithium-ion battery was charged to 4.5 V at a constant current of 0.5C, charged at a constant voltage of 4.5 V until the current was 0.025C, left standing for 10 min, and then discharged to 3.0 V at a constant current of 2C. A discharge capacity at 25° C. and 2C was recorded as C₃. Discharge capacity retention rate at rate of 2C (%)=C₃/C_{2× 100}%.

### Example 1-1

### <Preparation of Electrolyte Solution>

In an argon atmosphere glove box with a water content of less than 10 ppm, diethyl carbonate and ethylene carbonate were mixed at a mass ratio of 1:1 to obtain a base solvent, and then a sulfonyl compound of Formula I-1 and a lithium salt lithium hexafluorophosphate (LiPF₆) were added to the base solvent and mixed uniformly to obtain an electrolyte solution. Based on a mass of the electrolyte solution, a mass percentage of the lithium salt LiPF₆ was 8%, a mass percentage W₁% of the sulfonyl compound was as shown in Table 1, and the balance was the base solvent.

### <Preparation of Carbon Nanotube Clusters>

Multi-walled carbon nanotubes and a dispersant sodium carboxymethyl cellulose at a mass ratio of 1:2 were added to a dispersion medium deionized water, and mixed uniformly to obtain a mixed solution with a solid content of 10 wt %. The mixed solution was added to a container containing grinding balls, that was, a ball mill; and the container was rotated to obtain a dispersion of carbon nanotube clusters, where an average diameter of the grinding balls was 1.5 mm, a rotation speed of the container was 3000 rpm, and a ball milling time was 1 h.

### <Preparation of Negative Electrode Plate>

A silicon-carbon composite material SiC as silicon-based particles, artificial graphite, a dispersion of carbon nanotube clusters, and a negative electrode binder styrene-butadiene rubber were mixed, and added with deionized water as a solvent to prepare a slurry with a solid content of 45 wt %. The slurry was uniformly stirred using a vacuum mixer to obtain a negative electrode slurry, where a mass ratio of the silicon-carbon composite material SiC as silicon-based particles, the artificial graphite, the carbon nanotube clusters, and the negative electrode binder styrene-butadiene rubber in the negative electrode slurry was 10:87.8:1:1.2. The negative electrode slurry was uniformly applied on one surface of a negative electrode current collector with a thickness of 6 μm, followed by drying at 120° C. to obtain a negative electrode plate having one surface coated with a negative electrode material layer. Then, the above steps were repeated on the other surface of a copper foil to obtain a negative electrode plate having both surfaces coated with the negative electrode material layer. After drying at 120° C., cold pressing was performed, followed by slitting and tab welding, to obtain a negative electrode plate with specifications of 78 mm×875 mm for later use, where a thickness of the single-sided negative electrode material layer was 54.5 μm, a coating weight of the single-sided negative electrode material layer was 142 mg/1540 mm², and the average diameter D and average length L of the carbon nanotube clusters as well as the average diameter d of the carbon nanotubes were as shown in Table 1.

### <Preparation of Positive Electrode Plate>

A positive electrode active material lithium cobalt oxide, a positive electrode conductive agent conductive carbon black (Super P), and a positive electrode binder polyvinylidene fluoride (PVDF) were mixed at a mass ratio of 97:1.4:1.6, and added with N-methylpyrrolidone (NMP) as a solvent to obtain a slurry with a solid content of 75 wt %. The slurry was uniformly stirred using a vacuum mixer to obtain a positive electrode slurry. The positive electrode slurry was uniformly applied on one surface of a positive electrode current collector aluminum foil with a thickness of 10 μm, followed by drying at 85° C. to obtain a positive electrode plate having one surface coated with a positive electrode material layer. Then, the above steps were repeated on the other surface of the positive electrode plate to obtain a positive electrode plate having both surfaces coated with the positive electrode material layer. After coating, the positive electrode plate was cold pressed, followed by slitting and tab welding, to obtain a positive electrode plate with specifications of 74 mm×867 mm for later use, where a coating weight of the single-sided positive electrode material layer was 267.8 mg/1540 mm², and a thickness of the single-sided positive electrode material layer was 42 μm.

### <Separator>

A polyethylene (PE) film with a thickness of 7 μm was used.

### <Preparation of Lithium-Ion Battery>

The above prepared positive electrode plate, separator, and negative electrode plate were stacked in sequence, with the separator placed between the positive electrode plate and the negative electrode plate to play a separation role, and then wound to obtain an electrode assembly. The electrode assembly was placed into an aluminum-plastic film packaging housing, and dried in a vacuum oven at 85° C. for 12 h to remove moisture, and the above prepared electrolyte solution was injected, followed by processes such as vacuum sealing, standing, formation (the battery was charged to 3.5 V at a constant current of 0.02C, then charged to 3.9 V at a constant current of 0.1C), shaping, and capacity testing, to obtain a lithium-ion battery.

### Examples 1-2 to 1-29

Examples 1-2 to 1-29 were the same as Example 1-1 except that the relevant preparation parameters were adjusted according to Table 1. When the mass percentage W₁% of the sulfonyl compound changed, the mass percentage of the base solvent changed accordingly, the proportion of each component in the base solvent remained unchanged, and the mass percentage of the lithium salt LiPF₆ remained unchanged; and when the mass percentage of the carbon nanotube clusters in the negative electrode material layer changed, the mass percentage of artificial graphite changed accordingly, and the mass percentages of silicon-based particles and negative electrode binder remained unchanged. In Example 1-29, a molar ratio of silicon element to oxygen element in the silicon-oxygen composite material was 1:1.

### Example 2-1

Example 2-1 was the same as Example 1-1 except that the following preparation method was used for the <preparation of electrolyte solution>.

### <Preparation of Electrolyte Solution>

In an argon atmosphere glove box with a water content of less than 10 ppm, diethyl carbonate and ethylene carbonate were mixed at a mass ratio of 1:1 to obtain a base solvent, and then a sulfonyl compound of Formula I-1, a first component fluoroethylene carbonate, and a lithium salt lithium hexafluorophosphate (LiPF₆) were added to the base solvent and mixed uniformly to obtain an electrolyte solution. Based on a mass of the electrolyte solution, a mass percentage W₁% of the sulfonyl compound was 50%, a mass percentage W₂% of the first component fluoroethylene carbonate was 5%, a mass percentage of the lithium salt LiPF₆ was 8%, and the balance was the base solvent.

### Examples 2-2 to 2-7

Examples 2-2 to 2-7 were the same as Example 2-1 except that the relevant preparation parameters were adjusted according to Table 2. When the mass percentage W₂% of the first component changed, the mass percentage of the base solvent changed accordingly, the proportion of each component in the base solvent remained unchanged, and the mass percentages of the sulfonyl compound and lithium salt LiPF₆ remained unchanged.

### Comparative Example 1

Comparative Example 1 was the same as Example 1-1 except that the <preparation of carbon nanotube clusters>was not included, the carbon nanotube clusters were replaced with the negative electrode conductive agent acetylene black in the <preparation of negative electrode plate>, and the following preparation method was used for the <preparation of electrolyte solution>.

### <Preparation of Electrolyte Solution>

In an argon atmosphere glove box with a water content of less than 10 ppm, diethyl carbonate and ethylene carbonate were mixed at a mass ratio of 1:1 to obtain a base solvent, and then the lithium salt lithium hexafluorophosphate (LiPF₆) was added to the base solvent and mixed uniformly to obtain an electrolyte solution. Based on a mass of the electrolyte solution, a mass percentage of the lithium salt LiPF₆ was 8%, and the balance was the base solvent.

### Comparative Example 2

Comparative Example 2 was the same as Example 1-1 except that the <preparation of electrolyte solution>was the same as that in Comparative Example 1.

### Comparative Example 3

Comparative Example 3 was the same as Example 1-1 except that the <preparation of carbon nanotube clusters>was not included, and the carbon nanotube clusters were replaced with the negative electrode conductive agent acetylene black in the <preparation of negative electrode plate>.

### Comparative Examples 4 to 7

Comparative Examples 4 to 7 were the same as Example 1-1 except that the relevant preparation parameters were adjusted according to Table 1. When the mass percentage W₁% of the sulfonyl compound changed, the mass percentage of the base solvent changed accordingly, the proportion of each component in the base solvent remained unchanged, and the mass percentage of the lithium salt LiPF₆ remained unchanged.

The preparation parameters and performance parameters of the examples and comparative examples are shown in Table 1 and Table 2.

TABLE 1

| | | | | | | | | | Discharge |
|---|---|---|---|---|---|---|---|---|---|
| | | | | | | Mass | | | capacity |
| | | | | | | percentage | | Cycling | retention |
| | | | | | | of carbon | | capacity | rate at |
| | Sulfonyl | W₁ | D | d | L | nanotube | Negative electrode | retention | rate of 2 C |
| | compound | (%) | (μm) | (nm) | (μm) | clusters (%) | active material | rate (%) | (%) |
| Example 1-1 | Formula I-1 | 50 | 3 | 12 | 20 | 1 | Silicon-carbon | 84.5 | 74.0 |
| | | | | | | | composite material + | | |
| | | | | | | | artificial graphite | | |
| Example 1-2 | Formula I-2 | 50 | 3 | 12 | 20 | 1 | Silicon-carbon | 84.0 | 72.7 |
| | | | | | | | composite material + | | |
| | | | | | | | artificial graphite | | |
| Example 1-3 | Formula I-7 | 50 | 3 | 12 | 20 | 1 | Silicon-carbon | 84.0 | 73.5 |
| | | | | | | | composite material + | | |
| | | | | | | | artificial graphite | | |
| Example 1-4 | Formula I-12 | 50 | 3 | 12 | 20 | 1 | Silicon-carbon | 83.9 | 73.4 |
| | | | | | | | composite material + | | |
| | | | | | | | artificial graphite | | |
| Example 1-5 | Formula I-19 | 50 | 3 | 12 | 20 | 1 | Silicon-carbon | 84.0 | 73.4 |
| | | | | | | | composite material + | | |
| | | | | | | | artificial graphite | | |
| Example 1-6 | Formula II-1 | 50 | 3 | 12 | 20 | 1 | Silicon-carbon | 83.7 | 72.8 |
| | | | | | | | composite material + | | |
| | | | | | | | artificial graphite | | |
| Example 1-7 | Formula II-2 | 50 | 3 | 12 | 20 | 1 | Silicon-carbon | 84.0 | 73.2 |
| | | | | | | | composite material + | | |
| | | | | | | | artificial graphite | | |
| Example 1-8 | Formula II-6 | 50 | 3 | 12 | 20 | 1 | Silicon-carbon | 83.9 | 72.8 |
| | | | | | | | composite material + | | |
| | | | | | | | artificial graphite | | |
| Example 1-9 | Formula II-10 | 50 | 3 | 12 | 20 | 1 | Silicon-carbon | 83.9 | 73.3 |
| | | | | | | | composite material + | | |
| | | | | | | | artificial graphite | | |
| Example 1-10 | Formula I-1 + | 25 + 25 | 3 | 12 | 20 | 1 | Silicon-carbon | 83.9 | 73.2 |
| | Formula II-1 | | | | | | composite material + | | |
| | | | | | | | artificial graphite | | |
| Example 1-11 | Formula I-1 | 10 | 3 | 12 | 20 | 1 | Silicon-carbon | 71.8 | 84.9 |
| | | | | | | | composite material + | | |
| | | | | | | | artificial graphite | | |
| Example 1-12 | Formula I-1 | 20 | 3 | 12 | 20 | 1 | Silicon-carbon | 74.6 | 81.8 |
| | | | | | | | composite material + | | |
| | | | | | | | artificial graphite | | |
| Example 1-13 | Formula I-1 | 70 | 3 | 12 | 20 | 1 | Silicon-carbon | 86.8 | 67.3 |
| | | | | | | | composite material + | | |
| | | | | | | | artificial graphite | | |
| Example 1-14 | Formula I-1 | 90 | 3 | 12 | 20 | 1 | Silicon-carbon | 84.0 | 61.1 |
| | | | | | | | composite material + | | |
| | | | | | | | artificial graphite | | |
| Example 1-15 | Formula I-1 | 50 | 0.2 | 12 | 20 | 1 | Silicon-carbon | 81.5 | 68.2 |
| | | | | | | | composite material + | | |
| | | | | | | | artificial graphite | | |
| Example 1-16 | Formula I-1 | 50 | 0.5 | 12 | 20 | 1 | Silicon-carbon | 82.6 | 72.3 |
| | | | | | | | composite material + | | |
| | | | | | | | artificial graphite | | |
| Example 1-17 | Formula I-1 | 50 | 5 | 12 | 20 | 1 | Silicon-carbon | 84.0 | 76.3 |
| | | | | | | | composite material + | | |
| | | | | | | | artificial graphite | | |
| Example 1-18 | Formula I-1 | 50 | 6.5 | 12 | 20 | 1 | Silicon-carbon | 81.2 | 71.3 |
| | | | | | | | composite material + | | |
| | | | | | | | artificial graphite | | |
| Example 1-19 | Formula I-1 | 50 | 3 | 3 | 20 | 1 | Silicon-carbon | 81.5 | 70.9 |
| | | | | | | | composite material + | | |
| | | | | | | | artificial graphite | | |
| Example 1-20 | Formula I-1 | 50 | 3 | 5 | 20 | 1 | Silicon-carbon | 83.2 | 75.0 |
| | | | | | | | composite material + | | |
| | | | | | | | artificial graphite | | |
| Example 1-21 | Formula I-1 | 50 | 3 | 20 | 20 | 1 | Silicon-carbon | 82.6 | 72.0 |
| | | | | | | | composite material + | | |
| | | | | | | | artificial graphite | | |
| Example 1-22 | Formula I-1 | 50 | 3 | 40 | 20 | 1 | Silicon-carbon | 82.1 | 71.1 |
| | | | | | | | composite material + | | |
| | | | | | | | artificial graphite | | |
| Example 1-23 | Formula I-1 | 50 | 3 | 12 | 3 | 1 | Silicon-carbon | 78.8 | 71.7 |
| | | | | | | | composite material + | | |
| | | | | | | | artificial graphite | | |
| Example 1-24 | Formula I-1 | 50 | 3 | 12 | 5 | 1 | Silicon-carbon | 79.4 | 72.0 |
| | | | | | | | composite material + | | |
| | | | | | | | artificial graphite | | |
| Example 1-25 | Formula I-1 | 50 | 3 | 12 | 30 | 1 | Silicon-carbon | 86.7 | 74.4 |
| | | | | | | | composite material + | | |
| | | | | | | | artificial graphite | | |
| Example 1-26 | Formula I-1 | 50 | 3 | 12 | 40 | 1 | Silicon-carbon | 86.9 | 74.6 |
| | | | | | | | composite material + | | |
| | | | | | | | artificial graphite | | |
| Example 1-27 | Formula I-1 | 50 | 3 | 12 | 20 | 0.1 | Silicon-carbon | 83.6 | 73.4 |
| | | | | | | | composite material + | | |
| | | | | | | | artificial graphite | | |
| Example 1-28 | Formula I-1 | 50 | 3 | 12 | 20 | 2 | Silicon-carbon | 83.9 | 74.9 |
| | | | | | | | composite material + | | |
| | | | | | | | artificial graphite | | |
| Example 1-29 | Formula I-1 | 50 | 3 | 12 | 20 | 1 | Silicon-oxygen | 83.7 | 73.2 |
| | | | | | | | composite material + | | |
| | | | | | | | artificial graphite | | |
| Comparative | / | / | / | / | / | / | Silicon-carbon | 67.5 | 55.0 |
| Example 1 | | | | | | | composite material + | | |
| | | | | | | | artificial graphite | | |
| Comparative | / | / | 0.5 | 12 | 20 | 1 | Silicon-carbon | 68.0 | 67.9 |
| Example 2 | | | | | | | composite material + | | |
| | | | | | | | artificial graphite | | |
| Comparative | Formula I-1 | 50 | / | / | / | / | Silicon-carbon | 82.0 | 60.0 |
| Example 3 | | | | | | | composite material + | | |
| | | | | | | | artificial graphite | | |
| Comparative | Formula I-1 | 5 | 0.5 | 12 | 20 | 1 | Silicon-carbon | 70.2 | 68.8 |
| Example 4 | | | | | | | composite material + | | |
| | | | | | | | artificial graphite | | |
| Comparative | Formula I-1 | 92 | 3 | 12 | 20 | 1 | Silicon-carbon | 83.0 | 60.5 |
| Example 5 | | | | | | | composite material + | | |
| | | | | | | | artificial graphite | | |
| Comparative | Formula I-1 | 50 | 0.1 | 12 | 20 | 1 | Silicon-carbon | 79.3 | 65.0 |
| Example 6 | | | | | | | composite material + | | |
| | | | | | | | artificial graphite | | |
| Comparative | Formula I-1 | 50 | 6.8 | 12 | 20 | 1 | Silicon-carbon | 77.8 | 66.3 |
| Example 7 | | | | | | | composite material + | | |
| | | | | | | | artificial graphite | | |

Note:
(1) “/” in Table 1 indicates no relevant preparation parameters; and (2) in Example 1-10, the “sulfonyl compound” is “Formula I-1 + Formula II-1”, and “W₁ (%)” is “25 + 25”, indicating that the sulfonyl compound includes the compound of Formula I-1 and the compound of Formula II-1; and based on a total mass of the electrolyte solution, the mass percentage of the compound of Formula I-1 is 25%, and the mass percentage of the compound of Formula II-1 is 25%.

From Examples 1-1 to 1-29 and Comparative Examples 1 to 7, it can be seen that the electrolyte solution containing the sulfonyl compound and the negative electrode plate containing the carbon nanotube clusters can synergize with each other. In Comparative Example 1, the negative electrode plate does not include carbon nanotube clusters and the electrolyte solution does not include a sulfonyl compound; in Comparative Example 2, the electrolyte solution does not include a sulfonyl compound; in Comparative Example 3, the negative electrode plate does not include carbon nanotube clusters; in Comparative Examples 4 and 5, the mass percentage W₁% of the sulfonyl compound in the electrolyte solution is not within the ranges provided in the present application; in Comparative Examples 6 and 7, the average diameter D of the carbon nanotube clusters is not within the ranges provided in the present application; and in Comparative Examples 1 to 7, the cycling capacity retention rate and/or discharge capacity retention rate at rate of 2C of the lithium-ion battery is smaller, indicating that the lithium-ion battery cannot achieve a balance between the cycling performance and the rate performance.

The type of the sulfonyl compound affects the cycling performance and rate performance of the lithium-ion battery. From Examples 1-1 to 1-10, it can be seen that by using the sulfonyl compound within the range provided in the present application, the cycling capacity retention rate and discharge capacity retention rate at rate of 2C of the lithium-ion battery are larger, indicating that the lithium-ion battery has good cycling performance and rate performance.

The mass percentage W₁% of the sulfonyl compound affects the cycling performance and rate performance of the lithium-ion battery. From Example 1-1, Examples 1-11 to 1-14, and Comparative Examples 4 and 5, it can be seen that when the value of W₁ is too small, the cycling capacity retention rate of the lithium-ion battery is smaller, such as in Comparative Example 4; and when the value of W₁ is too large, the cycling capacity retention rate and discharge capacity retention rate at rate of 2C of the lithium-ion battery are smaller, such as in Comparative Example 5, indicating that the lithium-ion battery cannot achieve a balance between the cycling performance and the rate performance. When the value of W₁ is within the range provided in the present application, the cycling capacity retention rate and discharge capacity retention rate at rate of 2C of the lithium-ion battery are larger, indicating that the lithium-ion battery has good cycling performance and rate performance.

The average diameter D of the carbon nanotube clusters affects the cycling performance and rate performance of the lithium-ion battery. From Example 1-1, Examples 1-15 to 1-18, and Comparative Examples 6 and 7, it can be seen that when the value of D is too small, the cycling capacity retention rate and discharge capacity retention rate at rate of 2C of the lithium-ion battery are smaller, such as in Comparative Example 6; and when the value of D is too large, the cycling capacity retention rate and discharge capacity retention rate at rate of 2C of the lithium-ion battery are smaller, such as in Comparative Example 7, indicating that the lithium-ion battery cannot achieve a balance between the cycling performance and the rate performance. When the value of D is within the range provided in the present application, the cycling capacity retention rate and discharge capacity retention rate at rate of 2C of the lithium-ion battery are larger, indicating that the lithium-ion battery has good cycling performance and rate performance.

The average diameter d of the carbon nanotubes affects the cycling performance and rate performance of the lithium-ion battery. From Example 1-1 and Examples 1-19 to 1-22, it can be seen that when the value of d is within the range provided in the present application, the cycling capacity retention rate and discharge capacity retention rate at rate of 2C of the lithium-ion battery are larger, indicating that the lithium-ion battery has good cycling performance and rate performance.

The average length L of the carbon nanotube clusters affects the cycling performance and rate performance of the lithium-ion battery. From Example 1-1 and Examples 1-23 to 1-26, it can be seen that when the value of L is within the range provided in the present application, the cycling capacity retention rate and discharge capacity retention rate at rate of 2C of the lithium-ion battery are larger, indicating that the lithium-ion battery has good cycling performance and rate performance, and the process is also easy to implement.

The mass percentage of the carbon nanotube clusters affects the cycling performance and rate performance of the lithium-ion battery. From Example 1-1 and Examples 1-27 and 1-28, it can be seen that when the mass percentage of the carbon nanotube clusters is within the range provided in the present application, the cycling capacity retention rate and discharge capacity retention rate at rate of 2C of the lithium-ion battery are larger, indicating that the lithium-ion battery has good cycling performance and rate performance.

The type of silicon-based particles affects the cycling performance and rate performance of the lithium-ion battery. From Example 1-1 and Example 1-29, it can be seen that by using the silicon-based particles within the range provided in the present application, the cycling capacity retention rate and discharge capacity retention rate at rate of 2C of the lithium-ion battery are larger, indicating that the lithium-ion battery has good cycling performance and rate performance.

TABLE 2

| | | | Cycling | Discharge |
|---|---|---|---|---|
| | | | capacity | capacity retention |
| | First | W₂ | retention rate | rate at rate of 2 C |
| | component | (%) | (%) | (%) |
| Example | / | 0 | 84.5 | 74.0 |
| 1-1 | | | | |
| Example | Fluoroethylene | 5 | 90.0 | 80.0 |
| 2-1 | carbonate | | | |
| Example | Fluoroethylene | 0.5 | 85.0 | 75.0 |
| 2-2 | carbonate | | | |
| Example | Fluoroethylene | 1 | 87.0 | 77.0 |
| 2-3 | carbonate | | | |
| Example | Fluoroethylene | 8 | 92.0 | 82.0 |
| 2-4 | carbonate | | | |
| Example | Fluoroethylene | 15 | 86.0 | 76.0 |
| 2-5 | carbonate | | | |
| Example | Fluoroethylene | 18 | 84.8 | 74.6 |
| 2-6 | carbonate | | | |
| Example | Vinylene | 5 | 89.0 | 79.0 |
| 2-7 | carbonate | | | |

Note:
“/” in Table 2 indicates no relevant preparation parameters.

The mass percentage W₂% of the first component affects the cycling performance and rate performance of the lithium-ion battery. From Example 1-1 and Examples 2-1 to 2-6, it can be seen that when the value of W₂ is within the range provided in the present application, the cycling capacity retention rate and discharge capacity retention rate at rate of 2C of the lithium-ion battery are larger, indicating that the lithium-ion battery has good cycling performance and rate performance.

The type of the first component affects the cycling performance and rate performance of the lithium-ion battery. From Example 2-1 and Example 2-7, it can be seen that by using the first component within the range provided in the present application, the cycling capacity retention rate and discharge capacity retention rate at rate of 2C of the lithium-ion battery are larger, indicating that the lithium-ion battery has good cycling performance and rate performance.

It should be noted that in this specification, relational terms such as first and second are only used to distinguish one entity or operation from another entity or operation, and do not necessarily require or imply any such actual relationship or sequence between these entities or operations. Moreover, the terms “include”, “comprise”, or any other variants thereof are intended to cover non-exclusive inclusion, such that a process, method, or article that includes a series of elements not only includes those elements, but also includes other elements not explicitly listed, or elements inherent to such process, method or article.

The various embodiments in this specification are described in a related manner, and the same or similar parts between the various embodiments can refer to each other. Each embodiment focuses on differences from other embodiments.

The above are only preferred embodiments of the present application and are not intended to limit the present application. Any modifications, equivalent substitutions, improvements, and the like made within the spirit and principles of the present application shall be included in the protection scope of the present application.

What is claimed is:

1. A secondary battery, comprising a negative electrode plate and an electrolyte solution, wherein the electrolyte solution comprises a sulfonyl compound, and the sulfonyl compound comprises at least one selected from the group consisting of a compound of Formula I and a compound of Formula II; wherein
a chemical formula of the compound of Formula I is: 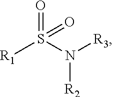
and
the chemical formula of the compound of Formula II is: 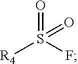
wherein, R₁ is selected from a fluorine atom and a C₁ to C₅ alkyl group, the C₁ to C₅ alkyl group is entirely or partially substituted by fluorine, R₂ and R₃ are each independently selected from a C₁ to C₅ alkyl group, R₂ and R₃ are capable of being connected into a ring through a single bond, and R₄ is selected from an unsubstituted or fluorine-substituted C₁ to C₅ alkyl group;
based on a mass of the electrolyte solution, a mass percentage of the sulfonyl compound is W₁%, and 10≤W₁≤90; and
the negative electrode plate comprises a negative electrode current collector and a negative electrode material layer disposed on at least one surface of the negative electrode current collector, the negative electrode material layer comprises carbon nanotube clusters and silicon-based particles, each carbon nanotube cluster comprises multiple carbon nanotubes, an average diameter of the carbon nanotube clusters is in the range of D μm, and 0.2≤D≤6.5.

2. The secondary battery according to claim 1, wherein the sulfonyl compound comprises the compound of Formula I; and the compound of Formula I comprises at least one of the following compounds:

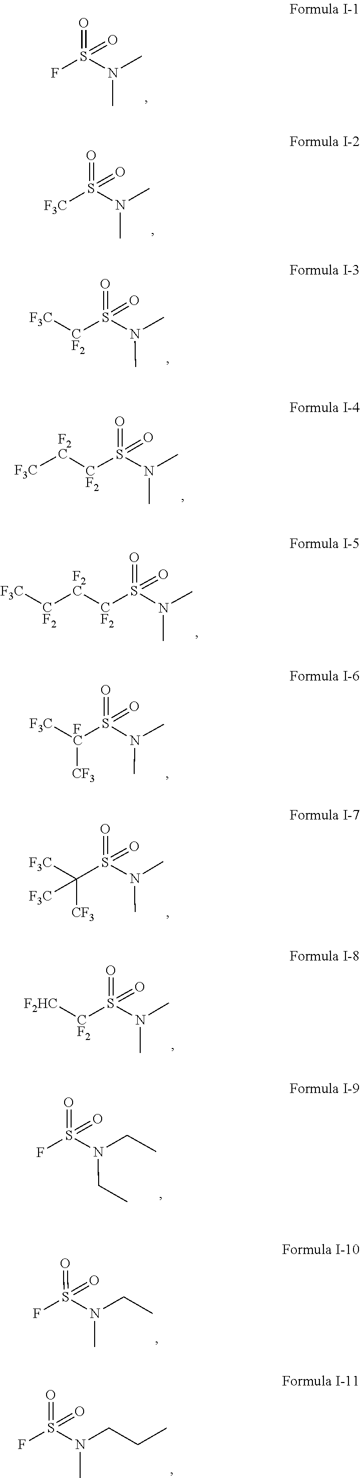

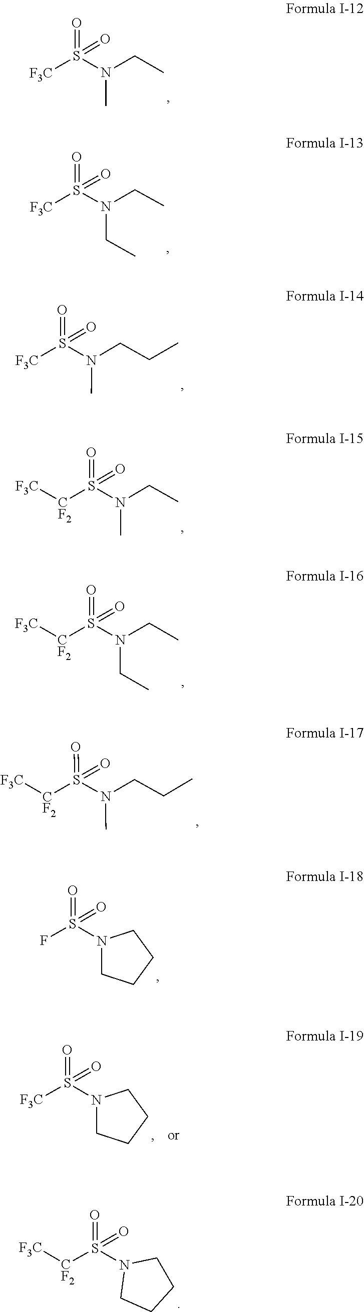

3. The secondary battery according to claim 1, wherein the sulfonyl compound comprises the compound of Formula II; and the compound of Formula II comprises at least one of the following compounds:

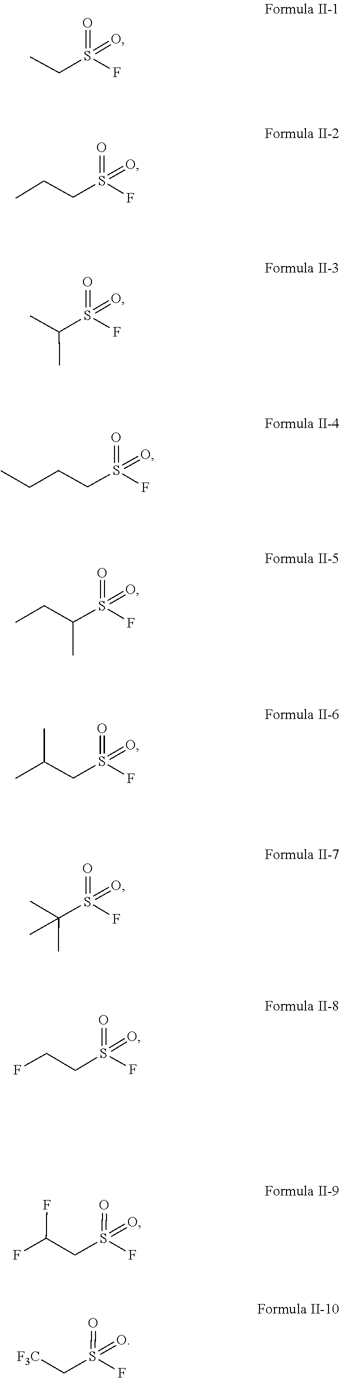

4. The secondary battery according to claim 1, wherein 20≤W₁≤70.

5. The secondary battery according to claim 1, wherein 0.5≤D≤5.

6. The secondary battery according to claim 1, wherein the electrolyte solution further comprises a first component; and the first component comprises at least one selected from the group consisting of fluoroethylene carbonate, difluoroethylene carbonate, vinylene carbonate, and ethylene vinyl carbonate; and
based on the mass of the electrolyte solution, a mass percentage of the first component is W₂%, wherein 0.5≤W₂≤15.

7. The secondary battery according to claim 6, wherein 1≤W₂≤8.

8. The secondary battery according to claim 1, wherein an average diameter of the carbon nanotubes is in the range of d nm, 3≤d≤40.

9. The secondary battery according to claim 8, wherein 5≤d≤20.

10. The secondary battery according to claim 1, wherein an average length of the carbon nanotube clusters is in the range of L μm, 3≤L≤40.

11. The secondary battery according to claim 10, wherein 5≤L≤30.

12. The secondary battery according to claim 1, wherein the negative electrode material layer satisfies at least one of the following:
(1) the silicon-based particles comprise at least one of pure silicon, a silicon alloy, a silicon-carbon composite material, or a silicon-oxygen composite material; or
(2) the carbon nanotubes comprise multi-walled carbon nanotubes.

13. The secondary battery according to claim 1, wherein based on a mass of the negative electrode material layer, a mass percentage of the carbon nanotube clusters is 0.1% to 2%.

14. An electronic apparatus, comprising a secondary battery; wherein the secondary battery comprises a negative electrode plate and an electrolyte solution, wherein the electrolyte solution comprises a sulfonyl compound, and the sulfonyl compound comprises at least one selected from the group consisting of a compound of Formula I and a compound of Formula II; wherein
a chemical formula of the compound of Formula I is: 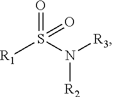
and
the chemical formula of the compound of Formula II is: 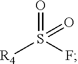
wherein, R₁ is selected from a fluorine atom and a C₁ to C₅ alkyl group, the C₁ to C₅ alkyl group is entirely or partially substituted by fluorine, R₂ and R₃ are each independently selected from a C₁ to C₅ alkyl group, R₂ and R₃ are capable of being connected into a ring through a single bond, and R₄ is selected from an unsubstituted or fluorine-substituted C₁ to C₅ alkyl group;
based on a mass of the electrolyte solution, a mass percentage of the sulfonyl compound is W₁%, and 10≤W₁≤90; and
the negative electrode plate comprises a negative electrode current collector and a negative electrode material layer disposed on at least one surface of the negative electrode current collector, the negative electrode material layer comprises carbon nanotube clusters and silicon-based particles, each carbon nanotube cluster comprises multiple carbon nanotubes, an average diameter of the carbon nanotube clusters is in the range of D μm, and 0.2≤D≤6.5.

15. The electronic apparatus according to claim 14, and the compound of Formula I comprises at least one of the following compounds: 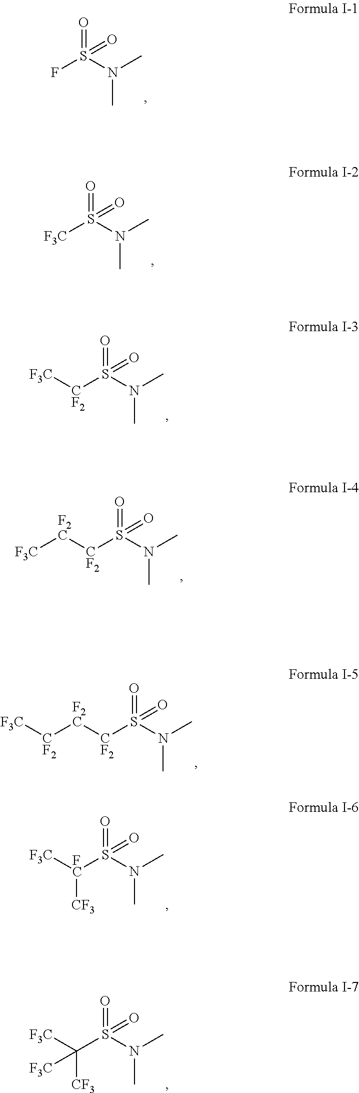 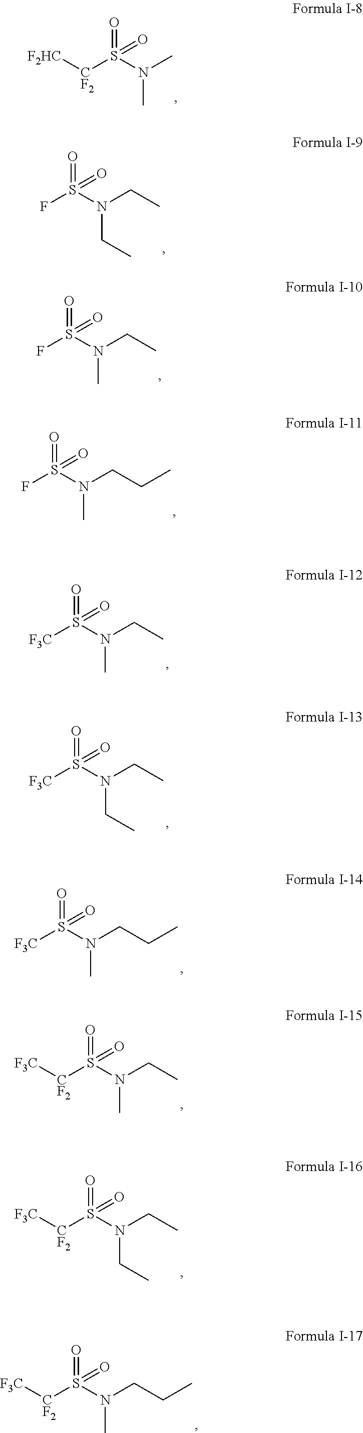 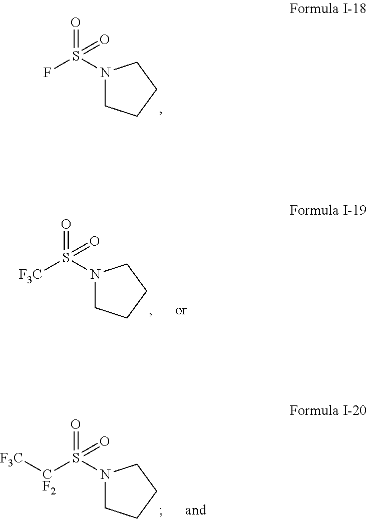 [SMILES: O=S(=O)(F)N1CCCC1 ; O=S(=O)(N1CCCC1)C(F)(F)F ; O=S(=O)(N1CCCC1)C(F)(F)C(F)(F)F]
the compound of Formula II comprises at least one of the following compounds:

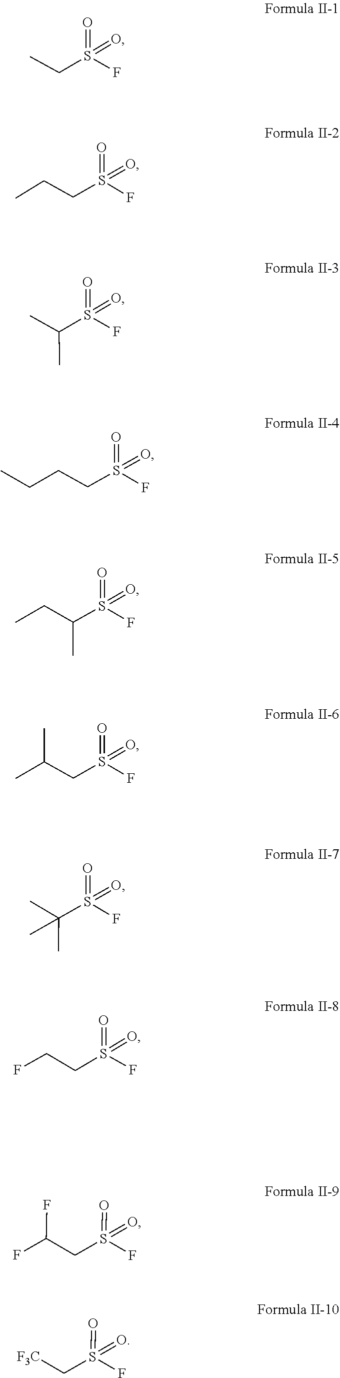

16. The electronic apparatus according to claim 14, wherein the electrolyte solution further comprises a first component, and the first component comprises at least one selected from the group consisting of fluoroethylene carbonate, difluoroethylene carbonate, vinylene carbonate, and ethylene vinyl carbonate; and
based on the mass of the electrolyte solution, a mass percentage of the first component is W₂%, wherein 0.5≤W₂≤15.

17. The electronic apparatus according to claim 14, wherein an average diameter of the carbon nanotubes is in the range of d nm, 3≤d≤40.

18. The electronic apparatus according to claim 14, wherein an average length of the carbon nanotube clusters is in the range of L μm, 3≤L≤40.

19. The electronic apparatus according to claim 14, wherein the negative electrode material layer satisfies at least one of the following:
(1) the silicon-based particles comprise at least one of pure silicon, silicon alloy, a silicon-carbon composite material, or a silicon-oxygen composite material;
(2) the carbon nanotubes comprise multi-walled carbon nanotubes;
$$20 \leq {W}_{1} \leq 70 ; or \qquad ( 3 )$$
$$0.5 \leq D \leq 5 . \qquad ( 4 )$$

20. The electronic apparatus according to claim 14, wherein based on a mass of the negative electrode material layer, a mass percentage of the carbon nanotube clusters is 0.1% to 2%.
